(19) United States
(12) Patent Application Publication
(10) Pub. No.: US 2009/0133537 A1
(43) Pub. Date: May 28, 2009

(54) BOTTLE CAP REMOVER AND ASSEMBLY METHODS

(76) Inventor: Rick A. Uglum, Chanhassen, MN (US)

Correspondence Address: MERCHANT & GOULD PC, P.O. BOX 2903, MINNEAPOLIS, MN, 55402-0903, US

(21) Appl. No.: 12/035,957

(22) Filed: Feb. 22, 2008

Related U.S. Application Data
(63) Continuation-in-part of application No. 29/293,479, filed on Nov. 26, 2007, now Pat. No. D581229.

(51) Int. Cl. B67B 7/16; B67B 7/62

(52) U.S. Cl. 81/3.37; 81/3.56; 29/428

(57) ABSTRACT

A bottle cap removing assembly includes a bottle cap removing device and a decorative cover member. The bottle cap removing device includes an outer housing and a cap engaging assembly at least partially positioned within the outer housing. At least a portion of the outer housing includes a cylindrical shape. The decorative cover member is mounted to the bottle cap removing device with at least a portion of the bottle cap removing device exposed outside of the decorative cover member. The bottle cap removing device is configured to remove a bottle cap by movement of the cap engaging assembly relative to the outer housing.

### RELATED APPLICATIONS

This application is a Continuation-In-Part of U.S. patent application Ser. No. 29/293,479 titled NOVELTY BOTTLE CAP REMOVER, which is incorporated herein by reference in its entirety. This application also relates to U.S. Pat. No. D546,150 and U.S. Pat. No. D558,010, which are incorporated herein by reference in their entirety.

### TECHNICAL FIELD

This disclosure relates to devices and methods for removing a bottle cap from a bottle.

### BACKGROUND

The use of caps to seal closed an otherwise open top of bottle is well known. A cap is press fit or twist fit onto the open end of the bottle to seal such as beverages and liquors within the bottle. The cap can be removed by rotating the cap by hand or by employing a separate bottle opening structure.

There are many types of bottle openers available. One type of bottle opener is a lever type opener for removing a cap by leverage. Another type of opener is a push type opener, such as the openers disclosed in U.S. Pat. No. 4,414,866 (Kichijyo) and U.S. Pat. No. 7,152,506 (Wang), which patents are incorporated herein by reference in their entirety. Push openers include an open end into which an upper end portion of a bottle, including the sealed cap, is inserted into. The cap is removed by pushing downward on an exterior body portion of the push opener, which activates an opening mechanism within the push opener to engage an edge of the cap and apply an upward directed force on the cap that removes the cap from the bottle.

### SUMMARY OF THE INVENTION

The present disclosure relates to a bottle cap removing assembly and methods of assembling and manufacturing a bottle cap removing assembly. An example bottle cap removing assembly includes bottle cap removing device and a decorative cover member. The bottle cap removing device includes an outer housing and a cap engaging assembly at least partially positioned within the outer housing. At least a portion of the outer housing includes a cylindrical shape. The decorative cover member is mounted to the bottle cap removing device with at least a portion of the bottle cap removing device exposed outside of the decorative cover member. The bottle cap removing device is configured to remove a bottle cap by movement of the cap engaging assembly relative to the outer housing.

The above summary is not intended to describe each disclosed embodiment or every implementation of the inventive aspects disclosed herein. Figures in the detailed description that follow more particularly describe features that are examples of how certain inventive aspects may be practiced. While certain embodiments are illustrated and described, it will be appreciated that disclosure is not limited to such embodiments.

### BRIEF DESCRIPTION OF THE DRAWINGS

FIG. 1 is a schematic perspective view of an example bottle cap removing assembly in accordance with principles of the present disclosure.

FIG. 2 is a schematic bottom view of the bottle cap removing assembly shown in FIG. 1.

FIG. 3 is a schematic exploded perspective view of the bottle cap removing assembly shown in FIG. 1.

FIG. 4 is a schematic side view of the bottle cap removing device of the bottle cap removing assembly shown in FIG. 1.

FIG. 5 is a schematic cross-sectional side view of the bottle cap removing device shown in FIG. 4.

FIG. 6 is a schematic cross-sectional side view of the bottle cap removing device shown in FIG. 4 in an activated state.

FIGS. 7-10 are schematic side views of example bottle cap removing assemblies having animal or fish shaped decorative covers.

FIG. 11 is a schematic side view of another example bottle cap removing assembly having a hunting themed decorative cover.

FIG. 11A is a schematic bottom perspective view of the decorative cover shown in FIG. 11.

FIG. 12 is a schematic side view of another example bottle cap removing assembly having a fishing theme decorative cover.

FIG. 13 is a schematic side view of another example bottle cap removing assembly having a food theme decorative cover.

FIG. 14 is a schematic side view of another example bottle cap removing assembly having a footwear theme decorative cover.

FIG. 15 is a schematic side view of another example bottle cap removing assembly having a water sport theme decorative cover.

FIG. 16 is a schematic side view of another example bottle cap removing assembly having a golf theme decorative cover member positioned at an end of the bottle cap removing device.

FIG. 17 is a schematic side view of another example bottle cap removing assembly having a helmet style decorative cover positioned at an end of the bottle cap removing device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The following discussion is intended to provide a brief, general description of a suitable environment in which the invention may be implemented. Although not required, the invention will be described in the general context of bottle opening devices, for example, a bottle opening device that removes a sealed cap from an otherwise open end of a bottle. The structure, creation, and use of some example devices are described hereinafter.

The example embodiments disclosed herein have wide application to a number of bottle cap opening assemblies, devices and assembly methods. For example, some of the disclosed methods relate to procedures and methods of assembling a bottle cap opening assembly that includes a bottle cap removing device and a decorative cover. Other example methods relate to preparation of a decorative cover for use with a bottle cap removing device. Therefore, while most of the embodiments described with reference to the attached figures are directed to bottle cap removing assemblies, devices and assembly methods, many other applications and related embodiments are envisioned.

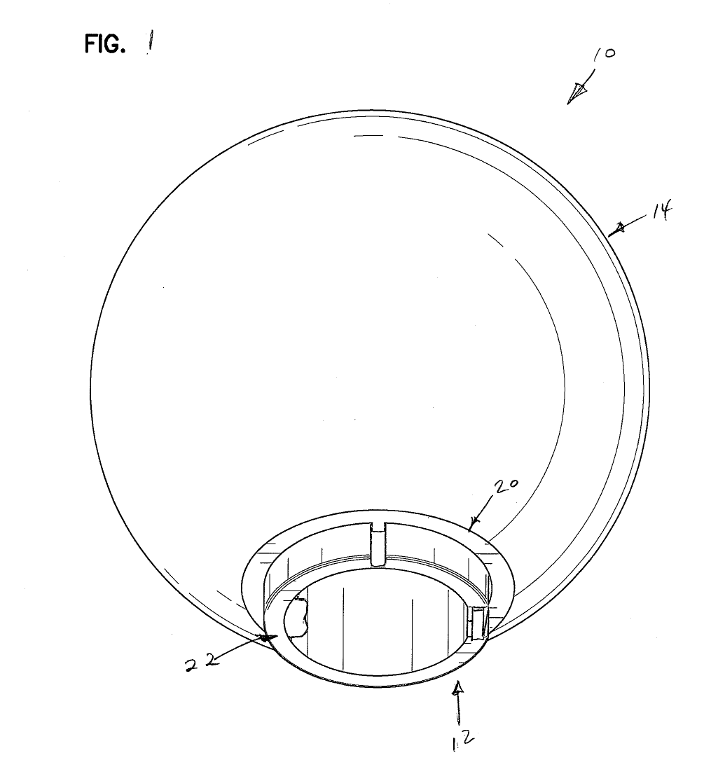

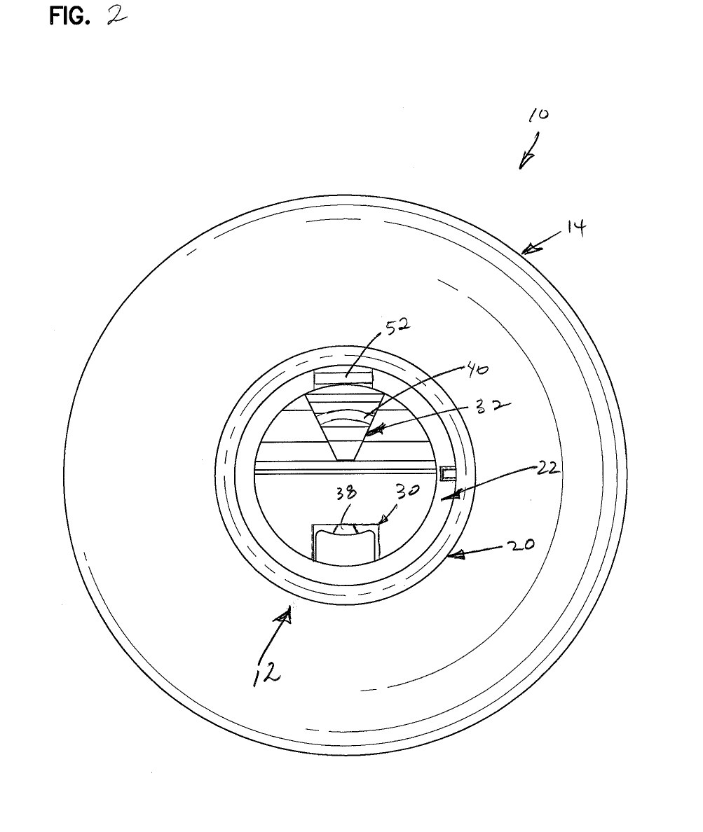

Referring now to FIGS. 1-3, an example bottle cap removing assembly 10 is shown and described. The bottle cap removing device assembly 10 includes a bottle cap removing device 12 positioned within a decorative cover 14. The decorative cover 14 is shown having a generally spherical shape, which can represent a number of different objects such as a soccer ball, a baseball, a racquet ball, a tennis ball, a basketball, other round sports balls, and other round objects related to, for example, sports and outdoor activities.

Typically, the decorative cover 14 can either be a solid object from which a core of material is removed sufficient to permit the bottle cap removing device 12 to be positioned therein, or is a generally hollow cover with an opening sized to receive the bottle cap removing device 12. In either arrangement, the decorative cover 14 is typically secured to the bottle cap removing device 12 along an exterior surface of the device 12 using, for example, adhesives, fasteners, or other attachment devices or means. Several example methods and constructions for assembling the bottle cap removing assembly 10 and other like assemblies is provided below with reference to the remaining figures.

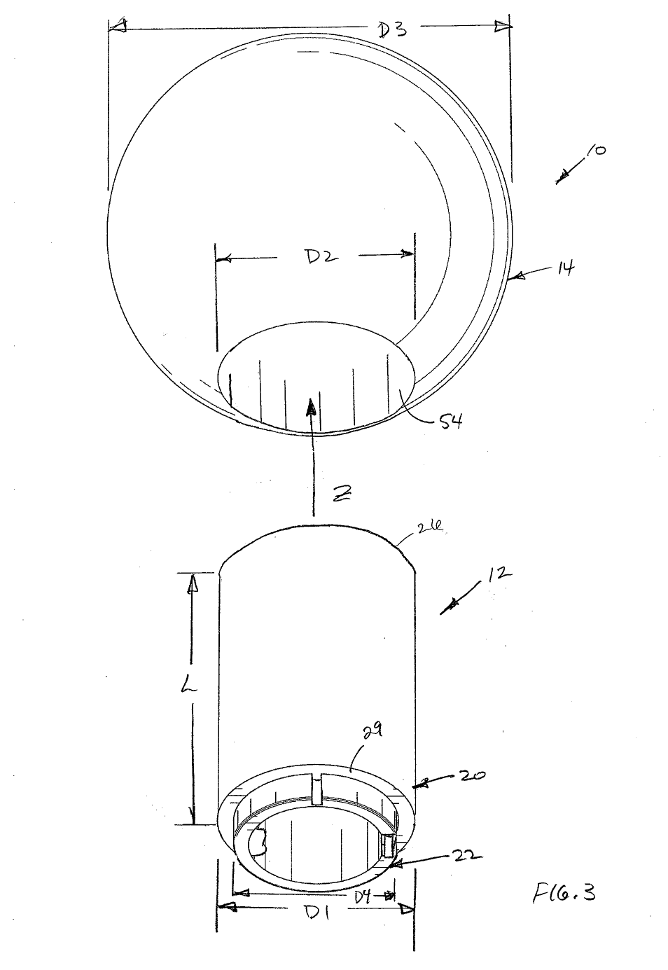

FIG. 3 illustrates an example bottle cap removing device 12 for use with the decorative cover 14. The decorative cover 14 defines a cavity 54 having a size and shape that corresponds to a size and shape of an outer housing 20 of the bottle cap removing device 12. The outer housing 20 has a closed end 26, an open end 29, an outer dimension D1, and a length L. Typically, the cavity 54, the decorative cover 14 has a dimension D2 that is substantially the same as the dimension D1 of the outer housing 20. The cavity 54 can have a depth (not shown) that is some portion of the length L, and typically less than or equal to the length L. In some arrangements, the depth of cavity 54 is substantially less than the length L so that the decorative cover 14 is positioned near the closed end 26 with much of the outer housing 20 exposed. In other arrangements, such as shown in FIGS. 1 and 2, the depth of the cavity 54 is at least the length L such that substantially all of the outer housing 20 is positioned within the decorative cover 14.

The outer housing 20 has a generally cylindrical outer profile with a circular cross-section (see FIG. 2). The cavity 54 can also have a generally cylindrical shape with a circular cross-section as well. However, as described above, the cavity 54 can have other shapes and sizes such as providing a decorative cover 14 with a generally hollow interior with limited contact with the outer surface of the outer housing 20. A stop member 28 can be positioned in the cavity 54 for engagement by features of the cap engaging assembly 22.

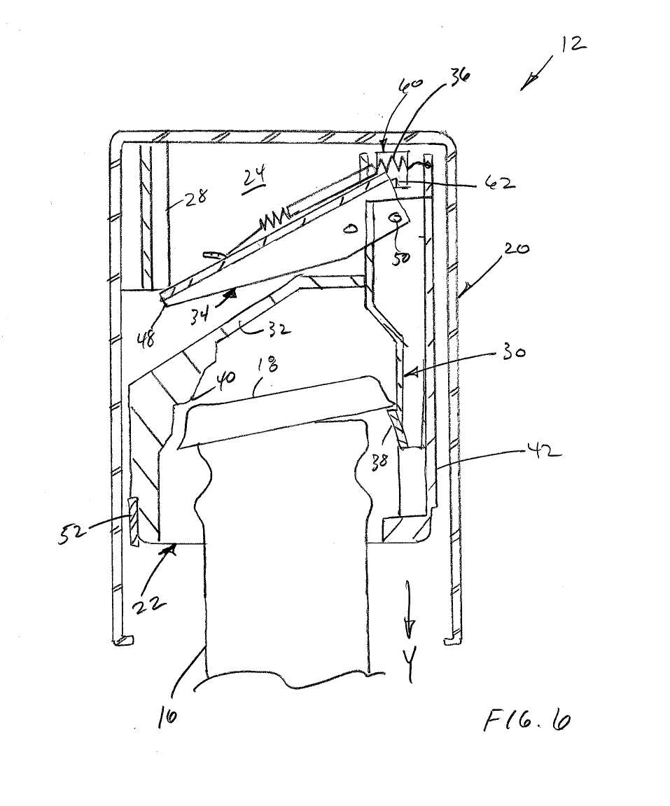

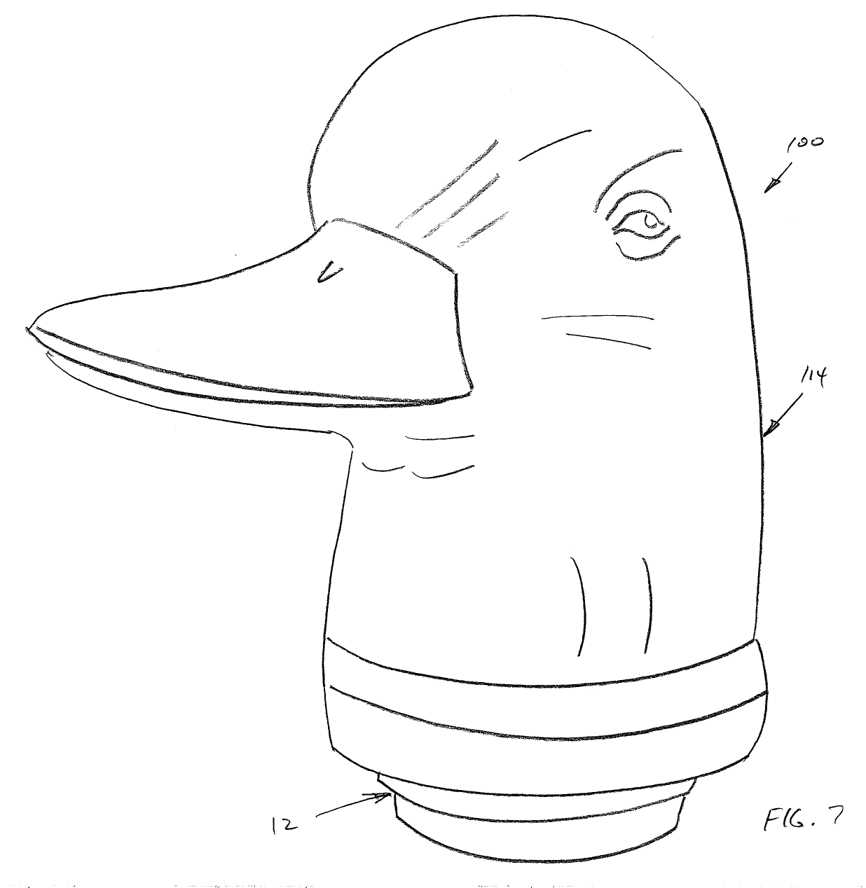

The bottle cap removing device 12 can further include a cap engaging assembly 22 that is at least partially positioned within the outer housing 20. FIGS. 5 and 6 illustrate internal features of the cap engaging assembly 22 in both a rest state (FIG. 5) and an activated state (FIG. 6).

The cap engaging assembly 22 includes a first operation arm 30, a second operation arm 32, an inclined arm 34, a spring 36, a support housing 42, and a magnet member 52. The first operation arm 30 defines an engagement projection 38 configured to engage a bottom surface of a bottle cap 18 to be removed from a bottle 16. The second operation arm 32 defines a contact surface 40 that engages a top end or side surface of the bottle cap 18. The inclined arm 34 includes first and second ends 46, 48 and a pivot point 50.

The cap engaging assembly 22 is movable in an activation direction X and in a return direction Y (see FIGS. 5 and 6 respectively) within a cavity 24 defined in the outer housing 20. When the cap engaging assembly 22 moves in the activation direction X, the spring 36 begins to apply a biasing force in the return direction Y that will return the cap engaging assembly 22 to the rest state shown in FIG. 5 upon release of an exterior applied force in the activation direction X. The bottle cap removing device 12 typically operates by first positioning the open end of the bottle 16 with cap 18 within the cap engaging assembly 22 as shown in FIG. 5. The user then grasps the outer housing 20 while holding the bottle 16 and moves the outer housing 20 in a direction Y, thus moving the cap engaging assembly 22 in the activation direction X relative to the housing 20. Relative movement of the cap engaging assembly 22 in the X direction relative to outer housing 20 moves the first operation arm 30 in the X direction relative to the bottle 16, thus removing the cap 18 from the bottle 16. A magnet 52 positioned at an open end of the cap engaging assembly 22 can help retain the bottle cap 18 at a position outside of the bottle cap removing device 12 after removal from the bottle 16.

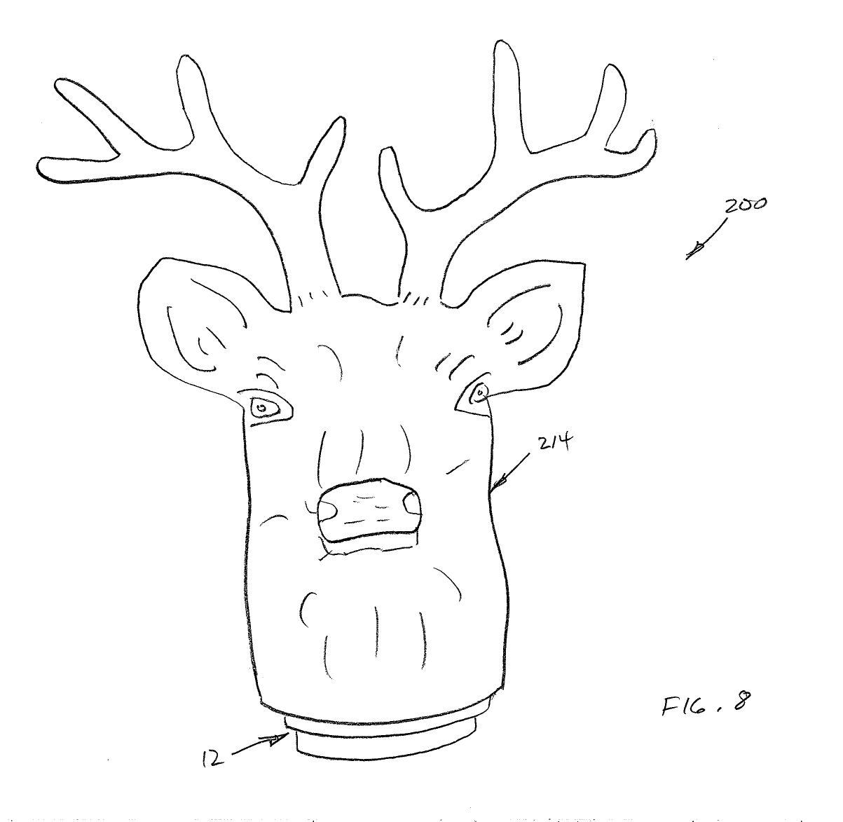

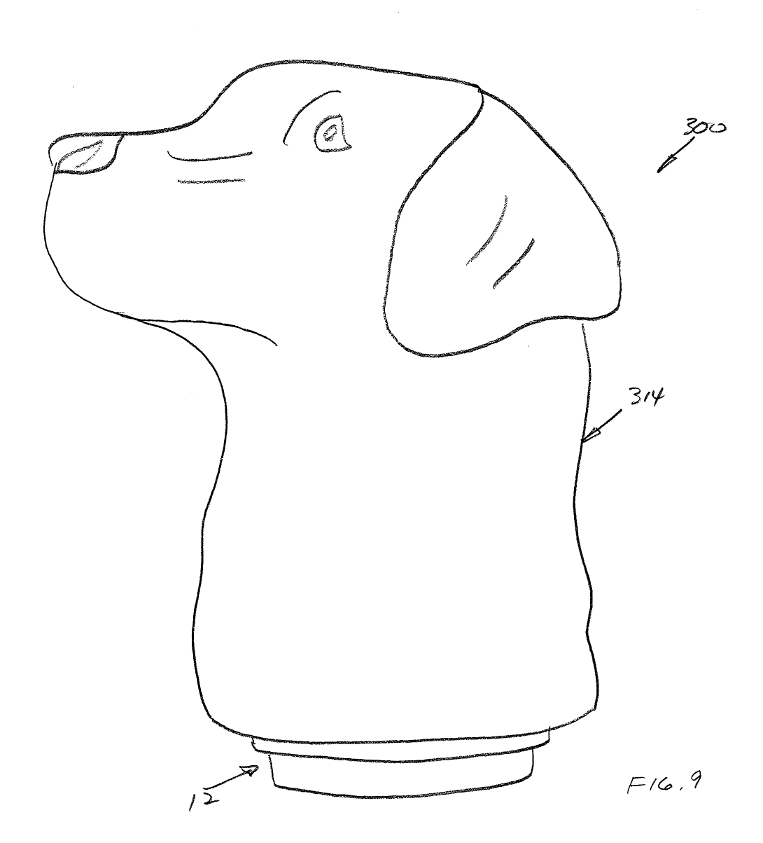

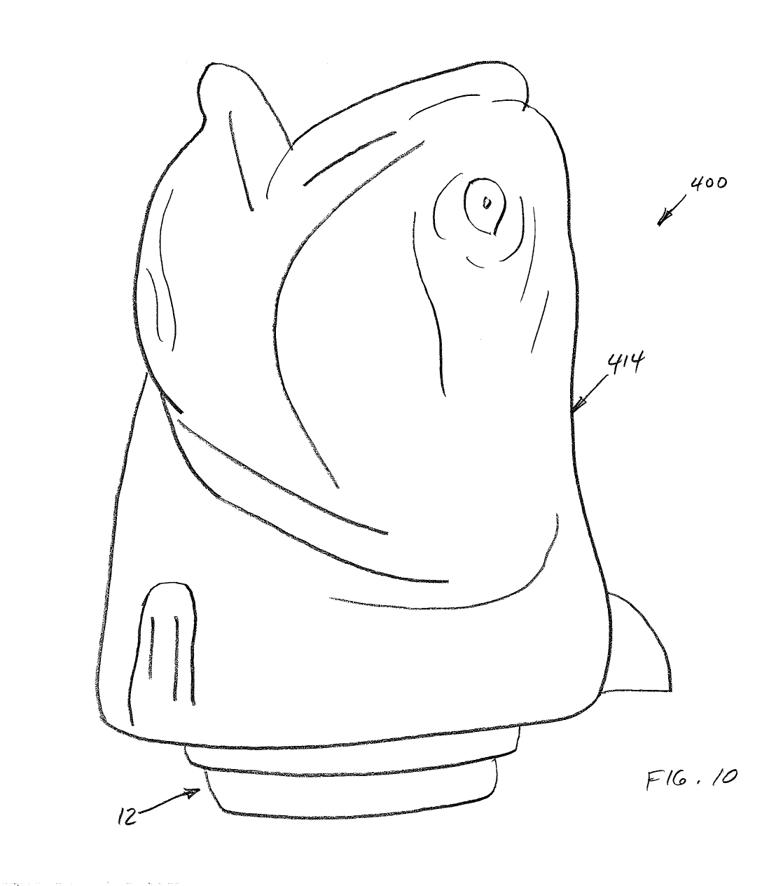

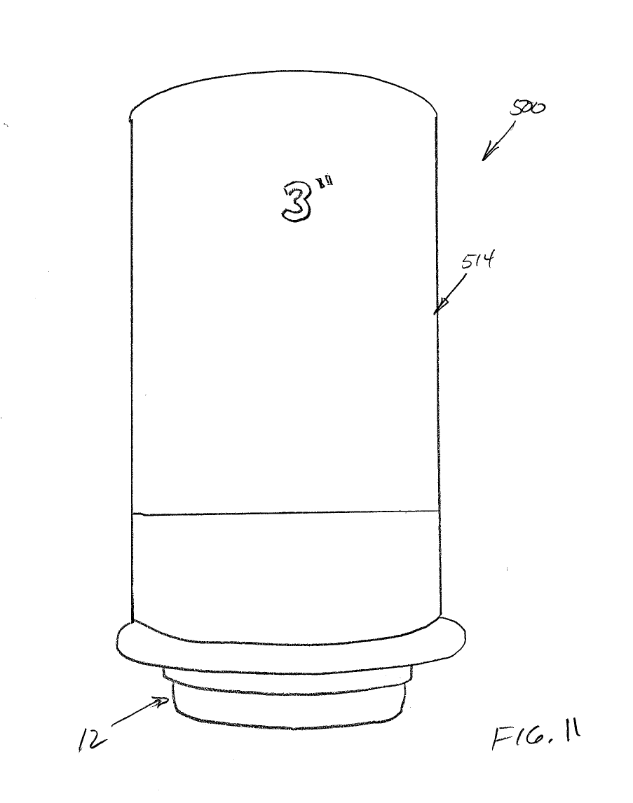

The bottle cap removing device 12 can further include a sound generating device 60. The sound generating device 60 can be positioned within the cavity 24 of the outer housing 20. The sound generating device 60 can include an actuator 62 that is activated upon removal of the bottle cap 18 from the bottle 16 using the bottle cap removing device 12. In one example arrangement, the sound generating device 60 is positioned in the cavity 24 near the closed end 26 of the outer housing 20. As the cap engaging assembly 22 moves in the activation direction X toward the closed end 26, the spring 36 moves into proximity of the actuator 62, thus signaling the sound generating device 60 to generate a audible sound. The audible sound can be associated with the decorative cover 14. For example, in use with the spherical decorative cover 14 of FIGS. 1-3, the sound generated by sound generating device 60 could be the sound of a bouncing basketball, the sound of a baseball being hit by a baseball bat, or the sound of a soccer ball being kicked. Other unique sounds are possible with use with other decorative cover members such as those cover members shown with reference to FIGS. 7-17, which will be described further below.

The actuator 62 can include various sensing technologies such as magnet, optical, IR, and the like. One example device for actuator 62 is Hall effect sensor that is activated when the spring 36 or other features of the cap engaging assembly 22 come within a certain distance of the actuator 62.

The actuator 62 is shown in FIGS. 5 and 6 mounted to the sound generating device 60. In other arrangements, the actuator 62 can be positioned at other locations inside or outside of the outer housing 20 in a different location than other features of the sound generating device 60.

The sound generating device 60 can include a plurality of electronic components such as a batter power source, a processor, a speaker, memory, and other components. The sound generating device 60 can be programmed to include the capability of producing more than one type of sound or series of sounds. For example, the sound generating device 60 can include two or more different sounds associated with a single decorative cover. The plurality of different sounds can be generated sequentially with each activation of the actuator 62. Alternatively, the plurality of sounds could be randomly generated with each activation of the actuator 62. In still further configurations and arrangements, a single sound generating device 60 can have stored a plurality of different sounds associated with different cover members, wherein certain of the plurality of sounds are selected in advance of associating the bottle cap removing device with a given decorative cover. In one example, different decorative covers can be used with a single bottle cap removing device 12, and the sound generating device 60 can be reconfigured to generate specific sounds for each different decorative cover member used with the bottle cap removing device.

There are many different designs for the decorative cover that represent different classes or groups. For example, FIGS. 7-10 illustrate example bottle cap removing assemblies 100-500 representing animal (e.g., ducks, deer, dog, fish) shaped decorative covers 114, 214, 314, 414 in combination with a bottle cap removing device 12. The assemblies 100-400 may be representative of the many different animals and fish designs that are possible. In each of the assemblies 100-400, the bottle cap removing device 12 is at least partially exposed at one end of the decorative cover.

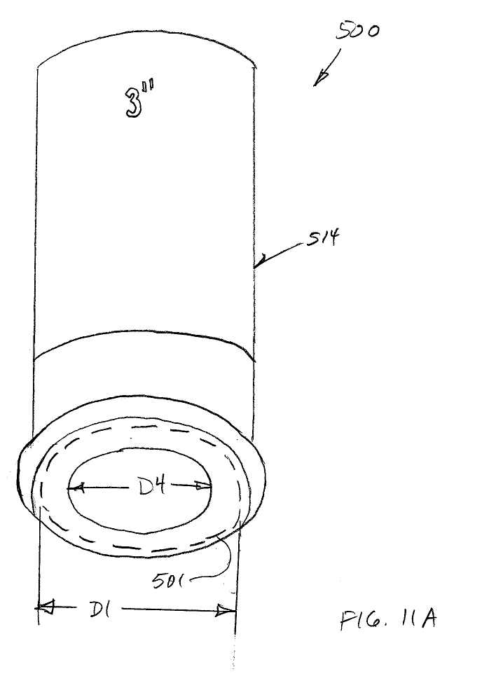

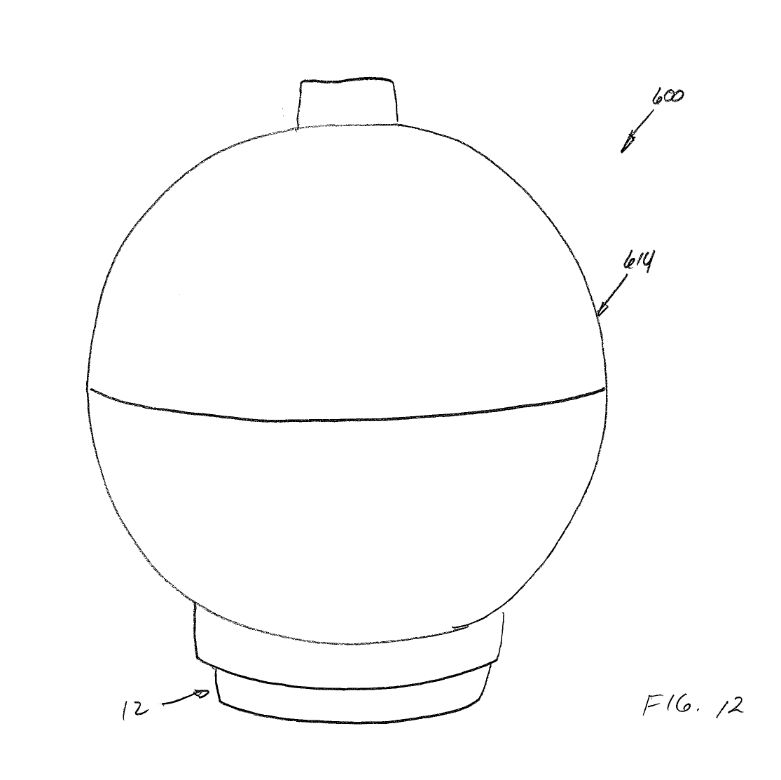

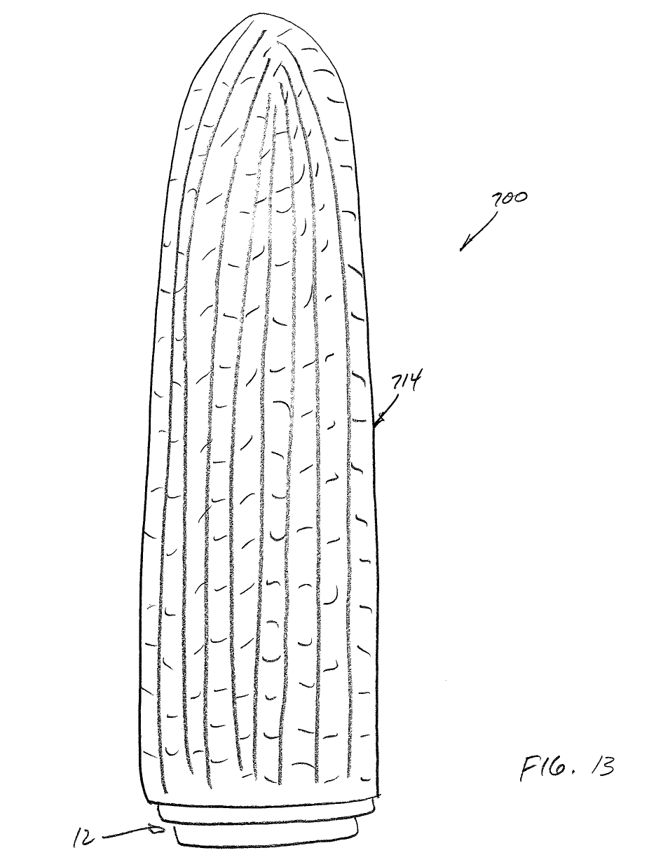

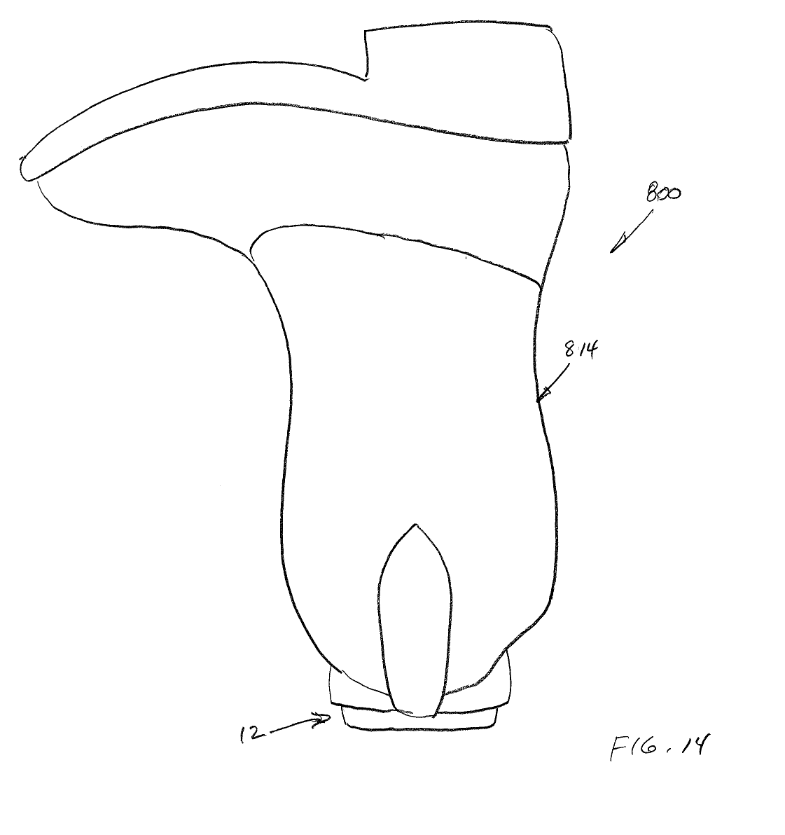

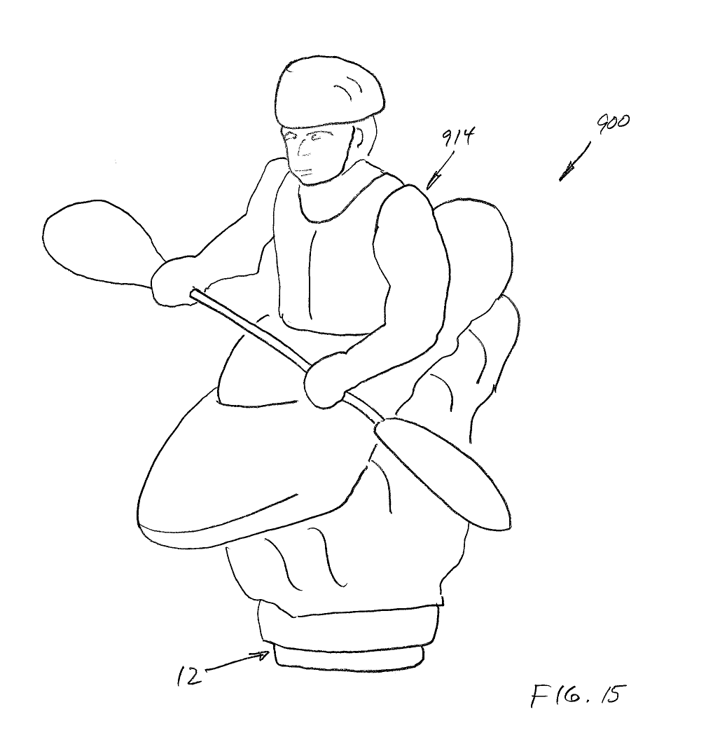

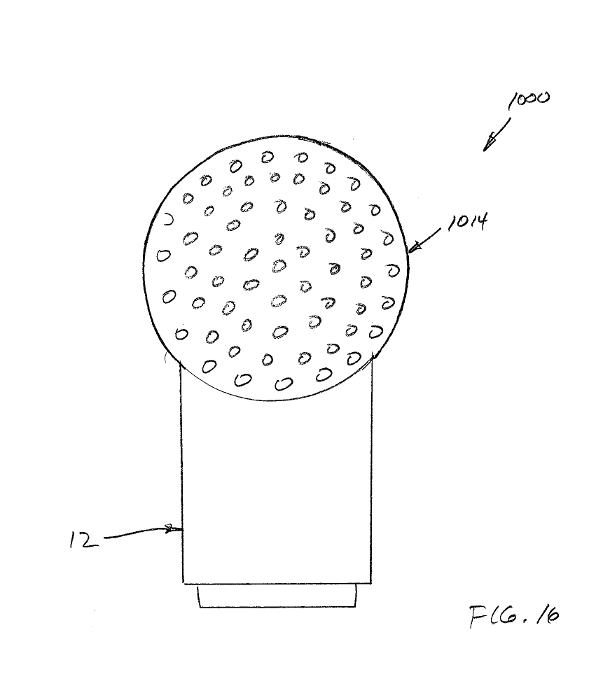

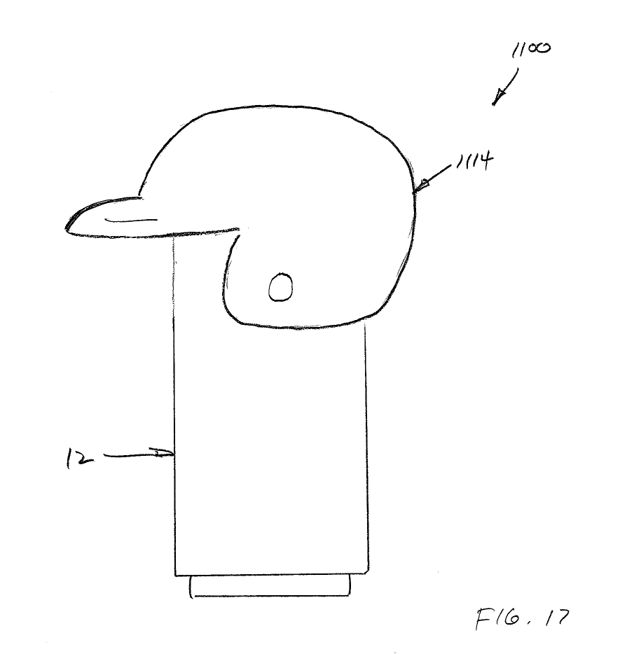

FIGS. 11-12 illustrate example sporting equipment (i.e., shotgun shell 500 having a cover 514 for hunting and fisher bobber 600 having a cover 614 for fishing). FIG. 13 represents a design category of food (i.e., a corn cob 700 having a cover 714). FIG. 14 illustrates a design area of footwear (i.e., a cowboy boot 800 having a cover 814). FIG. 15 illustrates a water sport (i.e., kayaking image 900 having a cover 914). FIG. 15 also illustrates a portion of a human (i.e., the upper body of a kayaker). FIG. 16 illustrates another version of the round ball shown in FIGS. 1-3 (i.e., a golf ball 1000 having a cover 1014). The golf ball shaped cover 1014 shown in FIG. 16 is positioned at the closed end of the bottle cap removing device 12. FIG. 17 illustrates a sports helmet assembly 1100 having a cover 1114 representing a sports helmet (i.e., a baseball batting helmet). The golf ball 1014 and helmet 1114 have a small size relative to the bottle cap removing device 12 as compared to the size of the cover 14 shown in FIGS. 1-3 relative to the cap removing device 12.

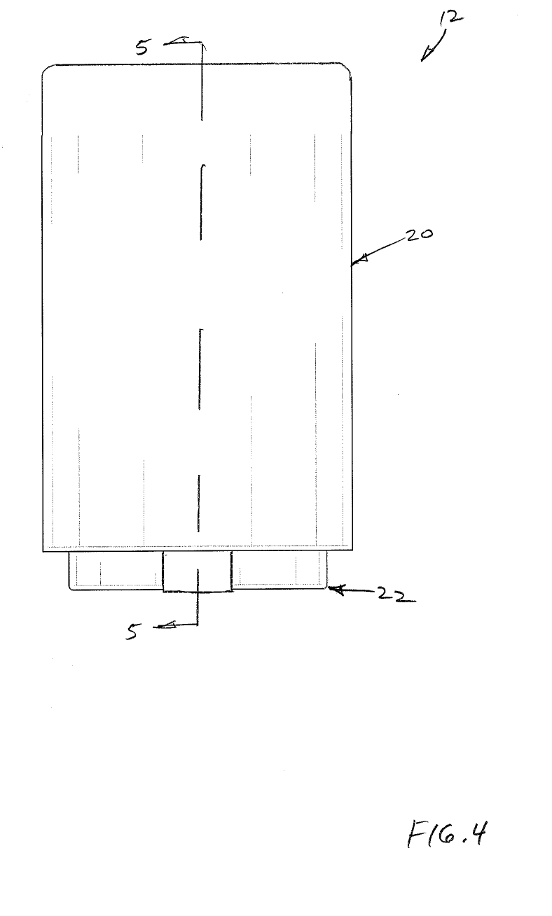

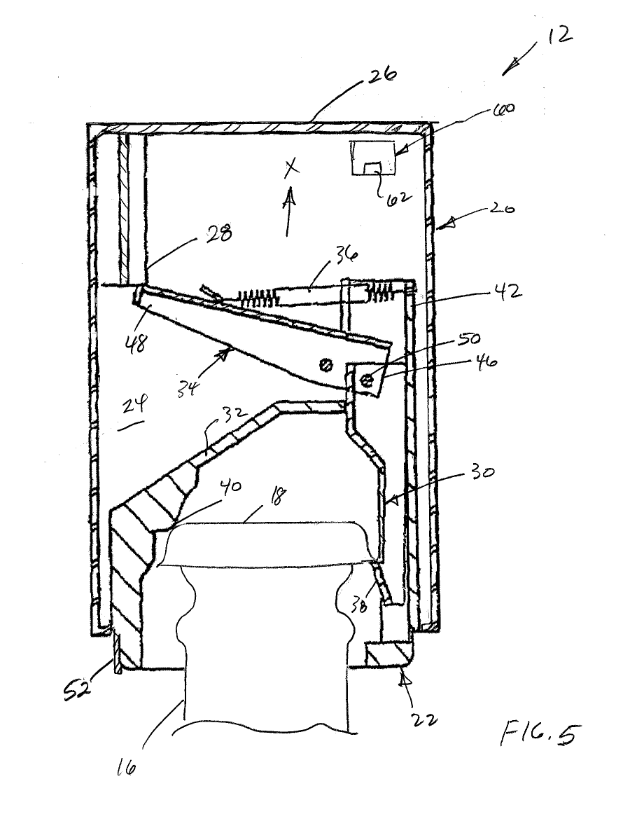

Any one of the decorative covers 14-1114 shown with reference to FIGS. 1-17 can be constructed as a solid object with a core removed sufficient to receive at least a portion of the bottle cap removing device 12, or can be a generally hollow construction having an opening sized to receive the bottle cap removing device 12. There are many different methods possible for preparing the decorative covers 14-1114 for assembly with the bottle cap removing device 12, as well as methods of assembling any one of the bottle cap removing assemblies 10-1100.

An example method of preparing any one of the decorative covers 14-1114 includes removing a generally cylindrical core having a circular cross-section from an otherwise solid decorative cover 14-1114. Removing the core of material can include drilling, cutting, or molding the solid decorative cover member 14 with the core preformed therein as part of the mold. After generating the solid decorative cover member with the core removed, the bottle cap removing device 12 can be at least partially inserted into the bore defined by the removed core. The bottle cap removing device 12 is secured to the decorative cover 14-1114 to provide the bottle cap removing assembly 10.

In another example, the decorative cover 14-1114 is formed as a generally hollow construction. The hollow decorative cover member 14 has an opening formed in a surface thereof having a dimension generally about the same size as dimension D1 of the outer housing 20 of the bottle cap removing device 12. The opening can be formed by cutting, stamping, or pre-forming during, for example, a molding process wherein the decorative cover 14-1114 is initially formed. In a later assembly step, the bottle cap removing device 12 is at least partially inserted into the opening of the decorative cover 14-1114. The bottle cap removing device 12 is secured to the decorative cover 14-1114 to provide a bottle cap removing assembly 10-1100.

In a yet further example, a pre-existing at least partially hollow decorative cover is provided with an opening having a dimension D4 as shown in FIG. 11A. The opening sides D4 can be sized for using a decorative cover in an alternative use such as for use as a trailer ball hitch cover. The dimension D4 may be smaller than the dimension D1, thus having a size insufficient for insertion of the bottle cap removing device 12 into the decorative cover (e.g., decorative cover 514). FIG. 11A illustrates a preferred opening size 501 having a dimension D1. The opening 501 can be achieved by modifying the decorative cover using, for example, cutting to remove the excess material surrounding the initial opening of dimension D4. After the decorative cover has been modified, the bottle cap removing device 12 can be inserted into the decorative cover and secured thereto to define the bottle cap removing assembly 10-1100. In one example, the dimension D1 is in the range of about 1.5 to 2 inches, and more preferably about 1⅞ inches.

One aspect of the present disclosure relates a bottle cap removing assembly that includes a bottle cap removing device and a decorative cover member. The bottle cap removing device includes an outer housing and a cap engaging assembly at least partially positioned within the outer housing. At least a portion of the outer housing includes a cylindrical shape. The decorative cover member is mounted to the bottle cap removing device with at least a portion of the bottle cap removing device exposed outside of the decorative cover member. The bottle cap removing device is configured to remove a bottle cap by movement of the cap engaging assembly relative to the outer housing. Typically, the outer housing includes an outer profile having circular cross section.

Another aspect of the present disclosure relates to a method of assembling a bottle cap removing assembly. The bottle cap removing assembly includes a bottle cap removing device and a decorative cover member. The bottle cap removing assembly includes an outer housing having a cylindrical shape and a cap engaging assembly sized to fit within the outer housing. The method includes the steps of positioning the bottle cap removing device within the decorative cover member, and securing the bottle cap removing device to the decorative cover member.

A yet further aspect of the present disclosure relates to a method of manufacturing a bottle cap removing assembly. The bottle cap removing assembly includes a bottle cap removing device having an outer housing and a bottle cap removing device. The outer housing has a cylindrical shape and defines a cavity. At least a portion of the bottle cap removing device is positioned in the cavity and is movable relative to the outer housing to remove a bottle cap. The method can include providing a cover member that includes an outer profile in the shape of a decorative object, an inner cavity, and an access opening defined in a surface thereof. The method can further include modifying a size of the access opening, inserting at least a portion of the bottle cap removing assembly through the modified access opening, and securing the bottle cap removing device to the cover member to form the bottle cap removing assembly.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A bottle cap removing assembly, comprising:
(a) an bottle cap removing device comprising an outer housing and a cap engaging assembly at least partially positioned within the outer housing, the bottle cap removing device being configured to remove a bottle cap, and at least a portion of the outer housing includes a cylindrical shape; and
(b) a decorative cover member mounted to the bottle cap removing device with at least a portion of the bottle cap removing device exposed outside of the decorative cover member.

2. The bottle cap removing assembly of claim 1, wherein the decorative cover member comprises a sphere shaped portion.

3. The bottle cap removing assembly of claim 1, wherein the bottle cap removing device is configured to remove a bottle cap by movement of the cap engaging assembly relative to the outer housing.

4. The bottle cap removing assembly of claim 3, wherein the outer housing includes an outer profile having a generally cylindrical shape with a circular cross section.

5. The bottle cap removing assembly of claim 4, wherein the decorative cover member defines a cavity, an opening to the cavity having a size and shape that substantially matches a size and shape of the cylindrical shape of the outer housing.

6. The bottle cap removing assembly of claim 3, wherein the cap engaging assembly includes a first operation arm, a second operation arm, an inclined arm, and a spring, the first operation arm having an engagement projection, the engagement projection configured to engage with a lower end of a bottle cap, the second operation arm configured to engage a top end of the bottle cap, the inclined arm having a first end that is hinged to the first operation arm and a second end that engages a stop on an internal surface of the housing, the spring providing a biasing force that moves the cap engaging assembly from an activated position wherein the cap is removed from the bottle upon activation of the cap engaging assembly and a rest position.

7. The bottle cap removing assembly of claim 1, wherein the decorative cover comprises an animal head shape.

8. The bottle cap removing assembly of claim 1, wherein the decorative cover comprises a food item shape.

9. The bottle cap removing assembly of claim 1, wherein the decorative cover comprises a sporting equipment shape.

10. The bottle cap removing assembly of claim 1, wherein the outer housing comprises a rigid material and the decorative cover comprises an elastic material.

11. A method of assembling a bottle cap removing assembly, the bottle cap removing assembly including a bottle cap removing device and a decorative cover member, the bottle cap removing assembly including an outer housing having a cylindrical shape and a cap engaging assembly sized to fit within the outer housing, the method comprising:
(a) positioning the bottle cap removing device within the decorative cover member; and
(b) securing the bottle cap removing device to the decorative cover member.

12. The method of claim 11, wherein the outer housing defines a cylindrical cavity that is accessible at an open end of the outer housing, and at least a portion of the cap engaging assembly has a cylindrical outer profile that extends out of the cavity at the open end of the outer housing.

13. The method of claim 1 1, wherein securing the bottle cap removing device to the decorative cover member includes applying an adhesive to at least one of the outer housing of the bottle cap removing device and the decorative cover member, and then curing the adhesive.

14. The method of claim 11, further comprising forming a cavity in the decorative cover member, the cavity being sized to receive at least a portion of the outer housing of the bottle cap removing device.

15. The method of claim 14, wherein the forming step includes removing a core of material from the decorative cover member.

16. The method of claim 14, wherein the decorative cover member includes a generally hollow cavity, the method further comprising forming an access opening in the decorative cover member that is sized to receive at least a portion of the outer cover member of the bottle cap removing device into the hollow cavity.

17. A method of manufacturing a bottle cap removing assembly, the bottle cap removing assembly including a bottle cap removing device having an outer housing and a bottle cap removing device, the outer housing having a cylindrical shape and defining a cavity, and at least a portion of the bottle cap removing device being positioned in the cavity and being movable relative to the outer housing to remove a bottle cap, the method comprising:
providing a cover member that includes an outer profile in the shape of a decorative object, an inner cavity, and an access opening defined in a surface thereof,
modifying a size of the access opening;
inserting at least a portion of the bottle cap removing assembly through the modified access opening; and
securing the bottle cap removing device to the cover member to form the bottle cap removing assembly.

18. The method of claim 17, wherein the step of modifying the size of the access opening includes cutting the surface of the cover member to enlarge the access opening.

19. The method of claim 17, wherein the securing step includes applying an adhesive to at least one of the cover member and the bottle cap removing device, and curing the adhesive.

20. The method of claim 17, wherein the cover member, prior to the modifying step, is configured as a trailer hitch ball cover and the access opening is sized to fit over a ball portion of a trailer hitch ball.
